(19) United States
(12) Patent Application Publication
(10) Pub. No.: US 2026/0349634 A1
(43) Pub. Date: Nov. 5, 2026

(54) IMAGE FORMING SYSTEM, METHOD FOR CONTROLLING IMAGE FORMING SYSTEM, AND NON-TRANSITORY COMPUTER-READABLE STORAGE MEDIUM

(71) Applicant: Konica Minolta, Inc., Tokyo (JP)

(72) Inventors: Yasushi TSUE, Tokyo (JP); Shinya SAITO, Tokyo (JP); Fuhito NAKAGAWA, Tokyo (JP)

(21) Appl. No.: 19/538,365

(22) Filed: Feb. 12, 2026

(30) Foreign Application Priority Data
Feb. 19, 2025 (JP) 2025-025001

(51) Int. Cl. G06F 3/12

(52) U.S. Cl. CPC G06F 3/1263; G06F 3/1207

(57) ABSTRACT

The present invention provides an image forming system, a method for controlling the image forming system, and a control program with which it is possible to prevent or reduce an occurrence of work mistakes in picking a flyer or bundling the flyer with a product, and to reduce time and labor for creating a set of flyers. The image forming system includes a hardware processor that controls an output order of output of printed materials to be sent together with a product by an image forming apparatus that generates the printed materials, and the hardware processor controls the output order of the printed materials based on the fact that the product and the printed materials are to be sent together.

### CROSS-REFERENCE TO RELATED APPLICATION

Japanese patent application No. 2025-025001 filed on Feb. 19, 2025, including description, claims, drawings, and abstract the entire disclosure is incorporated herein by reference in its entirety.

### BACKGROUND OF THE INVENTION

### 1. Technical Field

The present invention relates to an image forming system, a method for controlling the image forming system, and a non-transitory computer-readable storage medium storing a control program.

### 2. Description of Related art

In recent years, business to consumer (B to C) transactions through electronic commerce (EC) sites have tended to increase. A product purchased through an EC site is packed in a cardboard box or the like or enclosed in an envelope or the like in a logistics center and delivered to a consumer (orderer). At this time, a printed material such as a flyer related to the product is often sent together with the product. In this connection, Japanese Unexamined Patent Application Publication No. 2010-257054 discloses performing a shipping work using printed materials printed by a printer when the number of printed materials in stock in a stock shelf that manages the stock of printed materials is less than the number of ordered printed materials.

Usually, a flyer to be sent together with a product is designated in advance for each product by a brand owner (EC company) that is a seller of the product and that operates the EC site. In addition, when there is a plurality of flyers to be sent together with a product, the stacking order of the flyers is also usually designated by the EC company in advance.

Currently, a worker picks up necessary flyers from flyers that have been printed in advance in a printing company or the like and stored in a large amount in a warehouse of a logistics center in accordance with an instruction of an EC company, and stacks the flyers in a designated order to manually create a set of flyers. The created set of flyers is bundled or enclosed together with the product at the time of shipment of the product.

Furthermore, the content of the flyer to be sent to the orderer together with the product and the stacking order of the flyers may be changed as appropriate by the EC company. For example, EC companies include those that do not have a real store and have a contact with a customer only through an EC site. Such an EC company is expected to establish a relationship with an orderer or to further deepen the established relationship by providing updated information to the orderer to whom a flyer is to be sent by changing flyers to be bundled for each number of purchases even for the same product. Accordingly, the EC company is likely to be able to gain a customer who purchases the same product a plurality of times, that is, a so-called repeater.

### SUMMARY OF THE INVENTION

However, in a case where a flyer to be bundled with a product is switched and shipped for each product or for each number of purchases by a customer, the amount of work of a worker at a site where the product is shipped increases. In addition, when a flyer is individually picked together with a product at the time of shipment, a possibility of occurrence of a work mistake increases, and it takes more time. Therefore, under the present circumstances, for example, a worker creates a set of flyers in advance in his/her spare time for each purchased product or for each number of purchases, and when picking a product, the worker also picks the created set of flyers. Creating a set of flyers in advance facilitates the picking work performed by the worker, but if the set of flyers to be bundled with a product is changed, the worker needs to recreate the set of flyers. Further, when a set of flyers to be bundled with a product is changed, a flyer which cannot be used has to be discarded.

The present invention has been made in view of the above-mentioned circumstances. An object of the present invention is to provide an image forming system, a method for controlling the image forming system, and a non-transitory computer-readable storage medium storing a control program with which it is possible to prevent or reduce the occurrence of a work mistake during picking of a flyer or bundling of the flyer together with a product, and to reduce time and labor for creating a set of flyers.

To achieve at least one of the abovementioned objects, according to an aspect of the present invention, an image forming system reflecting one aspect of the present invention comprises the followings.

An image forming system includes a hardware processor that controls an output order of output of printed materials to be sent together with a product by an image forming apparatus that generates the printed materials, wherein the hardware processor controls the output order of the printed materials based on a fact that the product and the printed materials are to be sent together.

### BRIEF DESCRIPTION OF THE DRAWINGS

Advantages and features provided by one or more embodiments of the present invention will be more fully understood from the following detailed description and the accompanying drawings, which are for purposes of illustration only and are not intended to define the limits of the present invention.

FIG. 1 is a schematic block diagram illustrating an electronic commerce system according to a first embodiment;

FIG. 2 is a diagram illustrating an example of bundled flyer setting for a product a1;

FIG. 3 is a diagram illustrating an example of bundled flyer setting for a product a2;

FIG. 4 is a schematic diagram illustrating printed materials stacked in an output order to which the bundled flyer setting for the product a2 is applied;

FIG. 5 is a diagram illustrating an example of bundling condition setting;

FIG. 6 is a block diagram schematically illustrating the configuration of an image forming system;

FIG. 7 is a schematic block diagram illustrating the configuration of a print information acquirer illustrated in FIG. 6;

FIG. 8 is a diagram illustrating a shipping instruction list;

FIG. 9 is a diagram illustrating a print instruction list in a case where face-down output is performed;

FIG. 10 is a schematic diagram illustrating a stacking order of printed materials to be printed based on the print instruction list in FIG. 9;

FIG. 11 is a diagram illustrating a print instruction list in a case where face-up output is performed;

FIG. 12 is a schematic diagram illustrating a stacking order of printed materials printed based on the print instruction list in FIG. 11;

FIG. 13 is a flowchart illustrating the procedure of processing of controlling the output order of sheets;

FIG. 14 is a schematic block diagram illustrating the configuration of an image forming apparatus illustrated in FIG. 1;

FIG. 15 is a schematic block diagram illustrating the configuration of a controller illustrated in FIG. 14;

FIG. 16 is a flowchart illustrating the procedure of a method for printing a flyer in the EC system according to the first embodiment;

FIG. 17 is a subroutine flowchart illustrating the details of a process (step S205) of receiving and executing a print job in FIG. 16;

FIG. 18 is a schematic block diagram illustrating a modification example of the configuration of a print information acquirer illustrated in FIG. 6;

FIG. 19 is a schematic diagram illustrating a pattern table of a flyer to be bundled with a product;

FIG. 20 is a schematic diagram illustrating, as a comparative example, a shelf on which many boxes for storing flyers are arranged;

FIG. 21 is a flowchart illustrating the procedure of a method for printing a flyer in an EC system according to a second embodiment;

FIG. 22 is a subroutine flowchart illustrating the details of a process (step S206) of printing a document on a sheet in FIG. 21;

FIG. 23 is a flowchart illustrating the procedure of a method for printing a flyer in an EC system according to a third embodiment; and

FIG. 24 is a subroutine flowchart illustrating the details of a process (step S207) of ejecting a printed material onto a sheet ejection tray in FIG. 23.

### DETAILED DESCRIPTION

Embodiments of the present invention will be described below with reference to the drawings. It is to be noted that the scope of the present invention is not limited to the disclosed embodiments. In the description of the drawings, the same components are denoted by the same reference signs, and the redundant description is omitted. In addition, dimensional ratios in the drawings are exaggerated for convenience of description and may be different from actual ratios.

### FIRST EMBODIMENT

### Example of electronic commerce system

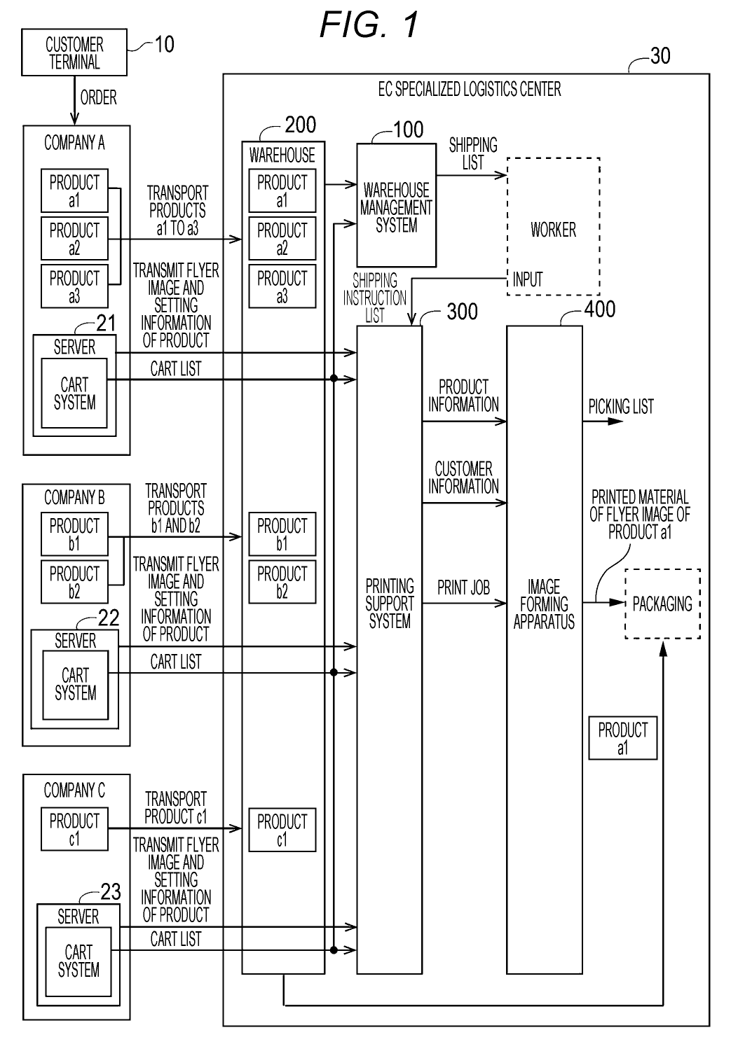

FIG. 1 is a schematic block diagram illustrating an electronic commerce (EC) system according to a first embodiment. In this EC system, a customer (user) uses a customer terminal 10 to order a product from a company A, a company B, or a company C as an EC company. FIG. 1 illustrates a case where an order is placed with the company A from the customer terminal 10. In a case where the customer orders products from the company B and the company C, the orders are similarly placed with the company B and the company C, although this is not illustrated. An order for a product is placed through a cart system installed in each of the company A, the company B, and the company C. FIG. 1 illustrates a case where the products of the company A are a1 to a3, the products of the company B are b1 and b2, and the product of the company C is c1. It should be noted that FIG. 1 does not illustrate the quantity of inventory of each product. An EC specialized logistics center 30 is a logistics center specialized for EC. The inventory of the products of each company in a warehouse 200 is managed by a warehouse management system 100. The products are transported from the companies A, B, and C to the EC specialized logistics center 30 according to the remaining number of the products, and are supplied to the warehouse 200.

The EC specialized logistics center 30 is provided with the warehouse management system 100, the warehouse 200, a printing support system 300, and an image forming apparatus 400 as constituent elements of the EC system. The warehouse management system 100 and the printing support system 300 may be implemented by an on-premise server (computer) or may be implemented by a cloud server.

When a product is ordered by the customer, a picking list is output from the image forming apparatus 400 in response to the order in the EC specialized logistics center 30. The picking list is also referred to as a shipping instruction, and is a list including information (for example, a storage location of a product, a product code, a quantity, and the like) necessary for the picking work by a worker. The worker who is in charge of shipping the product checks the picking list, picks the product stored in the product storage area of the warehouse 200, acquires a printed material of a flyer image of the product, inspects the product and the printed material, and then packs the product together with the printed material in a cardboard box. Note that the product may be picked using a machine (e.g., material handling). Furthermore, the flyer image of the product is not limited to the flyer of the ordered product, but includes a flyer image of a product or a service related to the ordered product.

The printed material of the flyer image of the product is ejected to a sheet ejection tray of the image forming apparatus 400 in accordance with the timing of a packing work for packing the product and the printed material by the worker. In the present embodiment, the order of ejection of the printed materials by the image forming apparatus 400 corresponds to, for example, the order in which the ordered plurality of products is bundled with the printed materials.

The companies A to C which are EC companies are provided with servers 21 to 23 as constituent elements of the EC system, respectively. The cart systems are implemented by the servers 21 to 23, respectively.

The warehouse management system 100, the warehouse 200, the printing support system 300, and the image forming apparatus 400 which are included in the EC specialized logistics center 30, the customer terminal 10, and the servers 21 to 23 of the companies A to C constitute the EC system according to the present embodiment.

### Customer terminal 10

The customer terminal 10 is, for example, a computer such as a personal computer, a smartphone, or a tablet terminal that is used by the customer to order a product. The customer terminal 10 includes input/output devices such as a touch screen, a keyboard, and a mouse (not illustrated). The customer performs operations such as searching for a product, selecting a product that the customer desires to purchase, and determining a payment method, using the input/output device of the customer terminal 10 at, for example, a shopping site provided on the Internet by the EC company.

### Servers 21 to 23

The servers 21 to 23 are computers installed in the companies A to C, respectively, and each execute a cart system to output a cart list in response to a customer's order. The cart list includes information regarding the product ordered by the customer, information about the customer such as the name and the address, a pickup request to the warehouse management system 100, and the like. The cart system is a system that provides a mechanism for allowing a customer to order a product and pay for the product on the Internet. In the mechanism provided by the cart system, a customer searches for a product on an EC site or a mail-order website, places the product that the customer wants to purchase in a shopping cart, and performs a purchase procedure to order the product. For the product for which the purchase procedure has been performed, payment is performed with, for example, a credit card. The cart system may have an order reception management function, a customer management function, a product management function, a sales promotion management function, and the like in addition to the cart function and the settlement function. The customer shops using a virtual shopping cart (basket) displayed on the screen of the customer terminal 10. For example, the customer can select a desired product by placing the product in a shopping cart in the same manner as that when the customer shops in a real store.

The servers 21 to 23 generate information regarding the product and information regarding the customer from information that is input when the customer orders the product. In the following, the information regarding a product is also referred to as product information, and the information regarding a customer is also referred to as customer information. The product information includes, for example, information related to a product storage area in the warehouse 200 and a delivery company that delivers the product, in addition to information specific to the product such as the name, the manufacturing number, and the manufacturing date of the product. The customer information includes information such as the customer's name, address, contact information, and the number of purchases for each product.

Furthermore, the servers 21 to 23 transmit, to the printing support system 300, a flyer image and setting information of a product created in advance by the EC company. The setting information includes bundled flyer setting and bundling condition setting. Outlines of the bundled flyer setting and the bundling condition setting will be described below.

### Bundled flyer setting

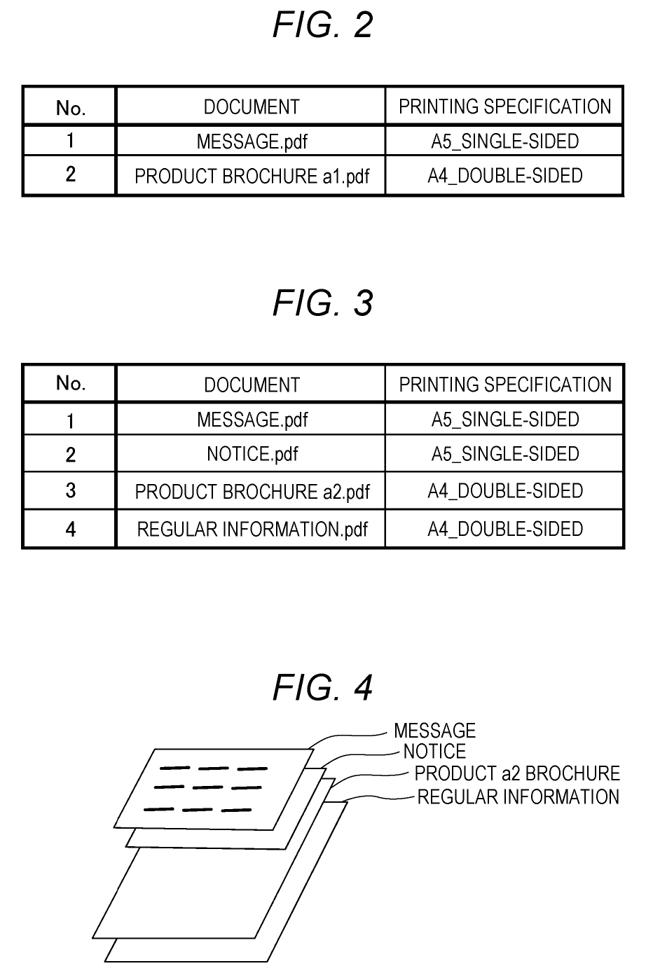

FIG. 2 is a diagram illustrating bundled flyer setting for the product a1, and FIG. 3 is a diagram illustrating bundled flyer setting for the product a2. The bundled flyer setting includes a combination of a document of a flyer to be bundled with a product and printing specifications (print settings) to be used in printing the document. The print settings include, for example, the number of pages, the number of copies, the type (recording medium), the size, and the basis weight of sheet, single-sided printing/double-sided printing, post-processing (stapling, bookbinding), marking (barcode, QR code), and the like. FIG. 4 is a schematic diagram illustrating printed materials stacked in the output order to which the bundled flyer setting for the product a2 is applied. The output order includes an image forming order and an ejection order, and the ejection order is an order of ejection of printed materials onto a sheet ejection tray of the image forming apparatus 400. As illustrated in FIGS. 2 and 3, the EC company sets flyers to be bundled for each product. In the bundled flyer setting, a document to be used for printing and print settings for printing the document are set together. In addition, when a plurality of flyers is to be bundled with the product, the bundled flyer setting is performed in consideration of the order in which the flyers are viewed when the customer opens the package. In the example illustrated in FIG. 3, the flyers are sequentially stacked in the order of No. 4 to No. 1. Therefore, when opening the package, the customer views the flyers in the order of a message, a notice, a product a2 brochure, and regular information from the top as illustrated in FIG. 4. That is, the flyers are ejected onto the sheet ejection tray of the image forming apparatus 400 in the order of the regular information, the product a2 brochure, the notice, and the message. The bundled flyer setting is stored in advance in a setting information storage 311, which will be described later, before the customer orders the product. The document of each product is stored in advance in a document database 320 to be described later. The file of the document of the product may be, for example, a text file or a document file in portable document format (PDF), Microsoft Word (registered trademark), Microsoft Excel (registered trademark), Microsoft PowerPoint (registered trademark), or the like.

### Bundling condition setting

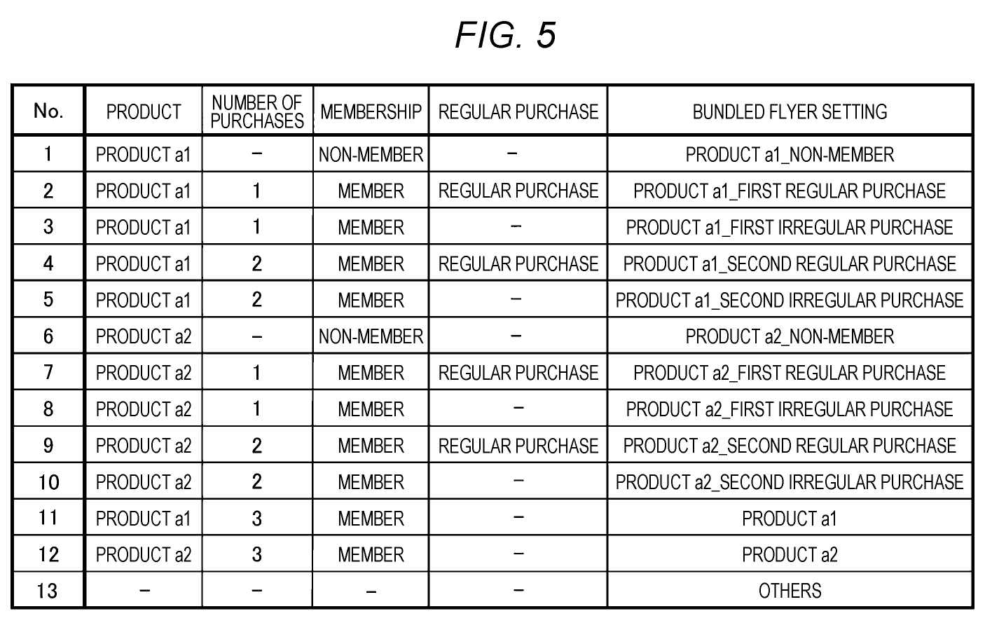

FIG. 5 is a diagram illustrating an example of the bundling condition setting. The bundling condition setting is a setting for selecting a bundled flyer setting that matches a predetermined condition from among a plurality of bundled flyer settings for each product. The predetermined conditions include, for example, the number of purchases, membership/non-membership, and whether or not the regular purchase is set. For example, in the example illustrated in FIG. 5, in a case where the customer makes the second regular purchase of the product a1, the bundled flyer setting No. 4 of “‎product a1_second regular purchase” is selected, and in a case where the customer makes the third regular purchase, the bundled flyer setting No. 11 of “product a1” is selected. The bundling condition setting is also stored in advance in the setting information storage 311 before the customer orders the product.

### EC specialized logistics center 30

### Warehouse management system 100

FIG. 1 will be referred to again for the description. The warehouse management system 100 is a warehouse management system (WMS) and has functions such as warehousing/delivery management and inventory management of products in the warehouse 200. Upon receiving the shipping instruction, the warehouse management system 100 generates a management number on the basis of the cart list and information acquired from the warehouse 200. The management number is a number managed by the warehouse management system 100 and the cart system in cooperation with each other. The shipping instruction can be generated, for example, on the basis of a shipment request transmitted to the warehouse management system 100 from each cart system when the cart system receives an order from a customer. The shipment request may be included in the cart list, for example. The warehouse management system 100 generates, every several hours to a day, a shipping list in which a management number and an instruction (order) regarding a product to be picked up from the warehouse 200, the quantity of the product, and the like are described. The shipping list includes information regarding shipment timing of the product, such as a shipment date and time.

In the example illustrated in FIG. 1, the warehouse 200 stores therein the products a1 to a3 transported from the company A, the products b1 and b2 transported from the company B, and the product c1 transported from the company C. In the warehouse 200, a sensor for detecting the remaining number of products is arranged, and information regarding the remaining number of products is sequentially transmitted to the warehouse management system 100. For example, when the remaining number of products stored in the warehouse 200 is zero or becomes small, a signal requesting supply of products can be transmitted from the warehouse 200 to the warehouse management system 100.

### Image forming system 500

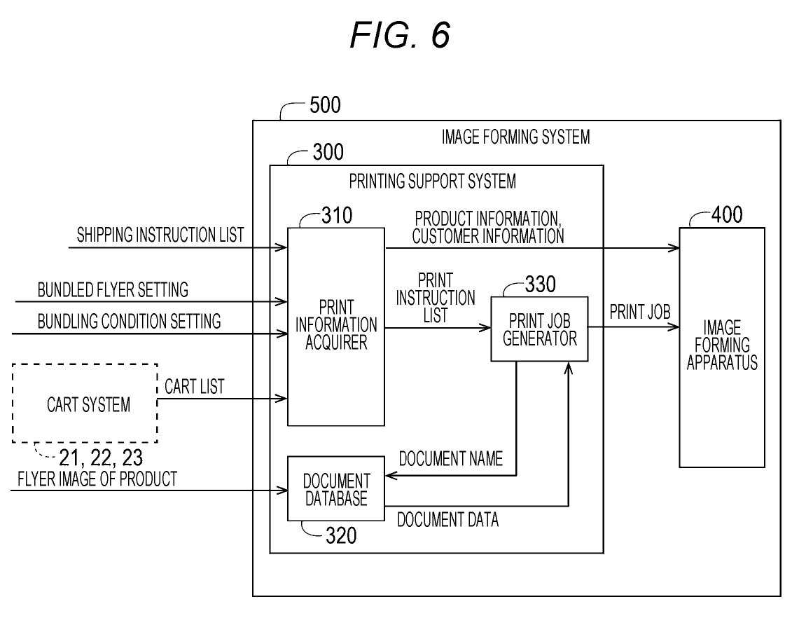

FIG. 6 is a block diagram illustrating a schematic configuration of the image forming system 500. The image forming system 500 includes the printing support system 300 and the image forming apparatus 400. The printing support system 300 is a system for supporting printing by the image forming apparatus 400. The printing support system 300 constitutes the image forming system 500 together with the image forming apparatus 400.

The printing support system 300 generates a print job (image forming job) on the basis of the shipping instruction list, the bundled flyer setting, the bundling condition setting, the cart list, and the flyer image of the product. The printing support system 300 includes a print information acquirer 310, a document database 320, and a print job generator 330. In the following, the functions of these components will be schematically described, and then the configuration of the print information acquirer 310 will be described in detail.

The print information acquirer 310 generates a print instruction list on the basis of the shipping instruction list, the bundled flyer setting, the bundling condition setting, and the cart list. The print instruction list is a list in which combinations of document names (document file names) and printing specifications (print settings) are arranged in the order of printing of the documents. The print information acquirer 310 also extracts the product information and the customer information from the cart list.

The document database 320 acquires the flyer image of the product from the servers 21, 22, and 23, and stores the flyer image of the product as a document in the database in association with the document name. The document database 320 outputs document data corresponding to the document name input from the print job generator 330. The print job generator 330 generates a print job on the basis of the print instruction list inputted from the print information acquirer 310 and the document data inputted from the document database 320.

### Print information acquirer 310

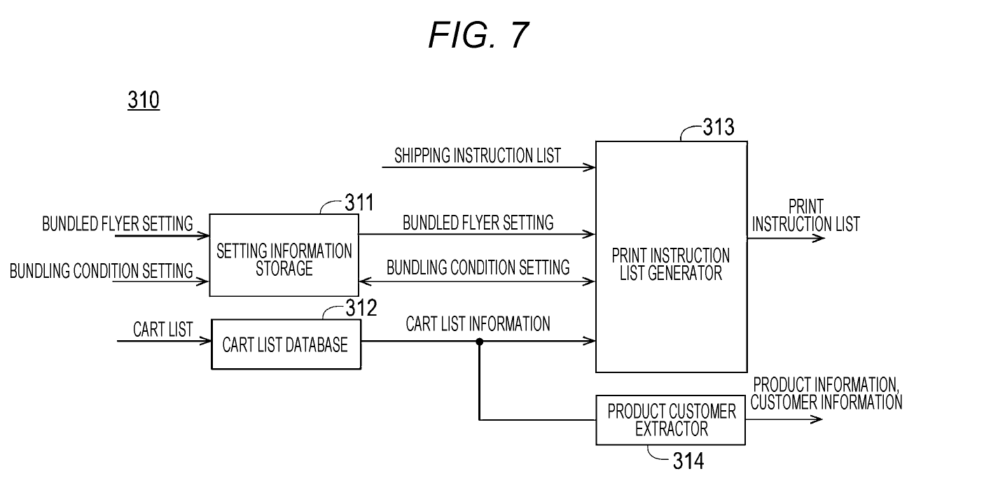

FIG. 7 is a schematic block diagram illustrating the configuration of the print information acquirer 310 illustrated in FIG. 6. The print information acquirer 310 includes a setting information storage 311, a cart list database 312, a print instruction list generator 313, and a product customer extractor 314.

### Shipping instruction list

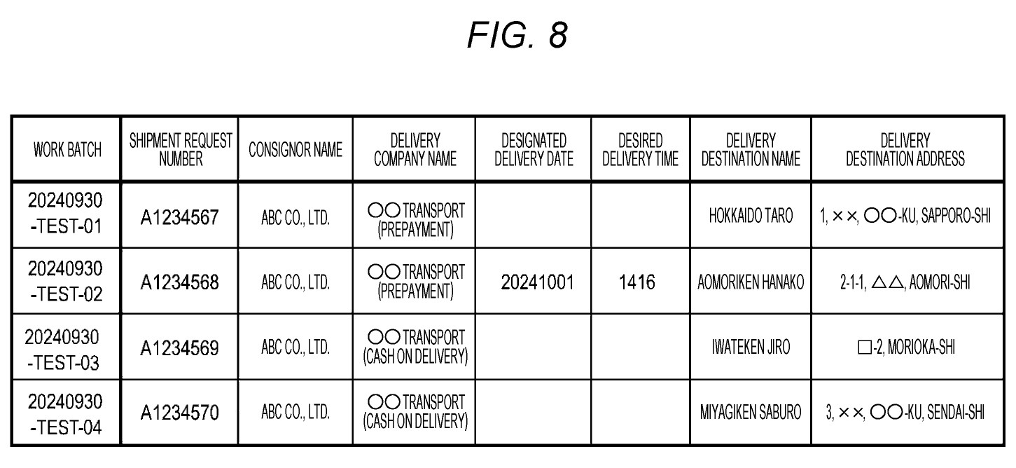

FIG. 8 is a diagram illustrating the shipping instruction list. The shipping instruction list is a list including items such as a shipment request number, a consignor name, a delivery company name, a designated delivery date, a desired delivery time, a delivery destination name, and a delivery destination address with respect to a package scheduled to be shipped in the orders described in the shipping list. The shipment request number corresponds to a management number managed by the warehouse management system 100 and the cart system in cooperation with each other. The shipping instruction list is created on the basis of the shipping list in consideration of items such as the date and time of shipping, the type and number of products, the delivery company, and the shipping destination (delivery destination), from the viewpoint of efficiently performing shipping work such as picking products and loading the products onto a truck.

For example, a work batch for collectively performing the shipping work for a plurality of packages to be shipped is added as an item in the shipping instruction list by the worker from the viewpoint of efficiently performing the shipping work. The worker creates a shipping instruction list for each work batch and inputs the list to the printing support system 300 (see FIG. 1). For example, in the example of FIG. 8, the work batches of 20240930-TEST-01 to 04 scheduled to be shipped on September 30, 2024 are collected as one unit. Note that as described later, the shipping instruction list can be automatically created on the basis of the shipping list.

For example, if the products of the same type that are scheduled to be shipped today among the products listed in the shipping list are filtered and further arranged by number, the work for picking up the same products continues, and further, the products using the same size of corrugated cardboard for packaging continue, and thus, the work is facilitated. In addition, by collecting work batches for each delivery company, sorting work at the time of loading on a truck is also facilitated. Further, in a case where the same delivery company uses different trucks for transportation depending on the delivery destination, the work batches are collected for each destination, by which the sorting work at the time of loading on the truck is facilitated. In the example illustrated in FIG. 8, the shipment is scheduled on September 30, 2024, and a work batch is created for each delivery company. That is, the delivery company for all the work batches 20240930-TEST-01 to 04 is “XX transport”.

The setting information storage 311 stores the bundled flyer setting and the bundling condition setting input from each of the servers 21 to 23 of the companies A to C.

The cart list database 312 stores a cart list input from the cart system of each of the companies A to C. The cart list database 312 outputs the cart list information stored in the database to the print instruction list generator 313 in response to a request from the print instruction list generator 313. Although the cart list information and the order described in the shipping list are not necessarily synchronized with each other for the ordered product, the cart list information can be read from the database by the print instruction list generator 313 at a necessary timing. The cart system transmits the shipment request to the warehouse management system 100 after receiving the order from the customer, so that all the information corresponding to the order described in the shipping list is included in the cart list information.

### Print instruction list

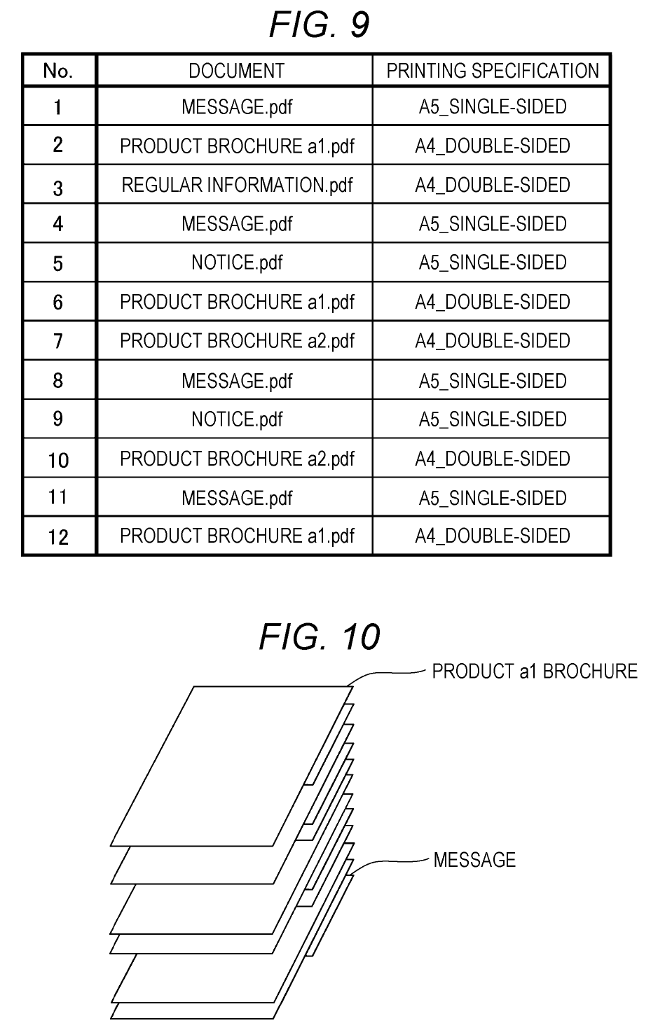

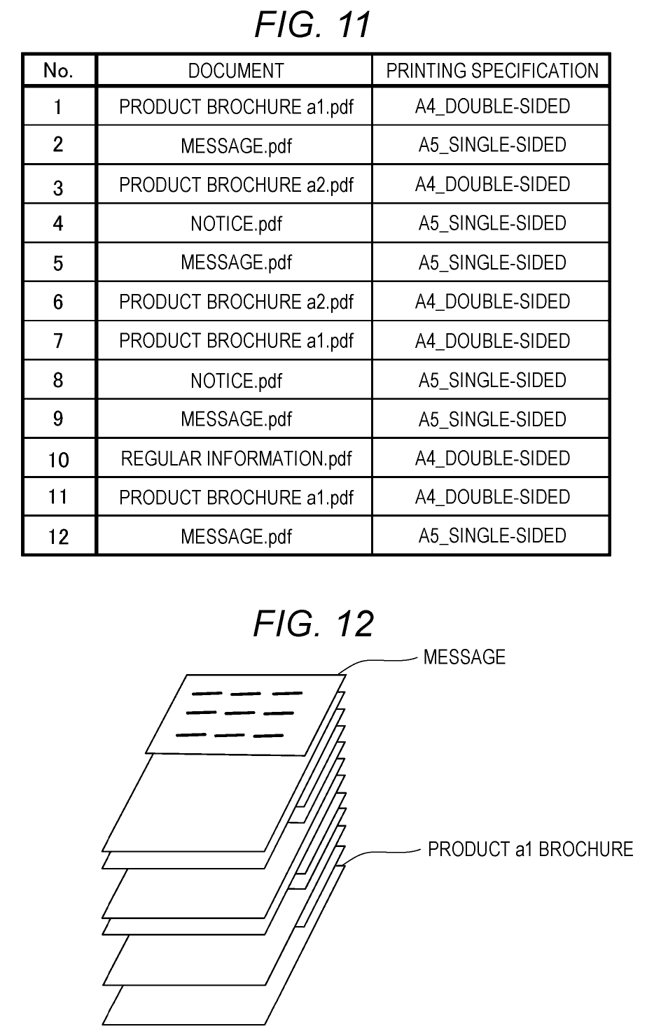

FIG. 9 is a diagram illustrating a print instruction list in a case where face-down output is performed, and FIG. 10 is a schematic diagram for describing the stacking order of printed materials printed based on the print instruction list in FIG. 9. FIG. 11 is a diagram illustrating a print instruction list in a case where face-up output is performed, and FIG. 12 is a schematic diagram for describing the stacking order of printed materials printed based on the print instruction list in FIG. 11.

The print instruction list generator 313 generates a print instruction list on the basis of the shipping instruction list, the bundled flyer setting, the bundling condition setting, and the cart list information. The print instruction list generator 313 acquires necessary information from the cart list information stored in the cart list database 312 by using the shipment request number in the shipping instruction list, and determines a bundling condition by the bundling condition setting. This is because the shipping instruction list does not include information regarding the product ordered by the customer, and thus the bundling condition cannot be determined only with the shipping instruction list.

The print instruction list generator 313 determines, for each order in the shipping instruction list, a product to be shipped based on the cart list information. As illustrated in FIG. 9, the print instruction list generator 313 can generate a print instruction list for the case where, for example, the bundled flyer setting is selected on the basis of the bundling condition setting for the determined product and face-down output is performed. In FIG. 9, for example, items No. 1 to No. 3 correspond to the bundled flyer settings in a case where the member purchases the product a1 for the second time, and items No. 4 to No. 7 correspond to the bundled flyer settings in a case where the non-member purchases the products a1 and a2 for the first time. In addition, items No. 8 to No. 10 correspond to the bundled flyer settings in a case where the non-member purchases the product a2 for the first time, and items No. 11 to No. 12 correspond to the bundled flyer settings in a case where the member purchases the product a1 for the third time.

For example, as illustrated in FIG. 10, the documents are printed in order from the top of the print instruction list illustrated in FIG. 9, whereby the face-down output is achieved in which the printed material of “message” is located at the bottom and the printed material of “product a1 brochure” is located at the top.

In addition, the print instruction list generator 313 determines a product to be shipped based on the cart list information and can also generate a print instruction list as illustrated in FIG. 11 for the case where, for example, the bundled flyer setting is selected on the basis of the bundling condition setting and face-up output is performed.

For example, as illustrated in FIG. 12, the documents are printed in order from the top of the print instruction list illustrated in FIG. 11, whereby the face-up output is achieved in which the printed material of “message” is located at the top and the printed material of “product a1 brochure” is located at the bottom.

As described above, when the product and the printed material are to be sent together, the print instruction list generator 313 selects the bundled flyer setting on the basis of the bundling condition setting, and generates the print instruction list in the order of the documents defined by the selected bundled flyer setting. That is, the print instruction list generator 313 functions as a controller that controls the output order of printed materials by generating a print instruction list including the order of documents and controlling the order of printing of the documents.

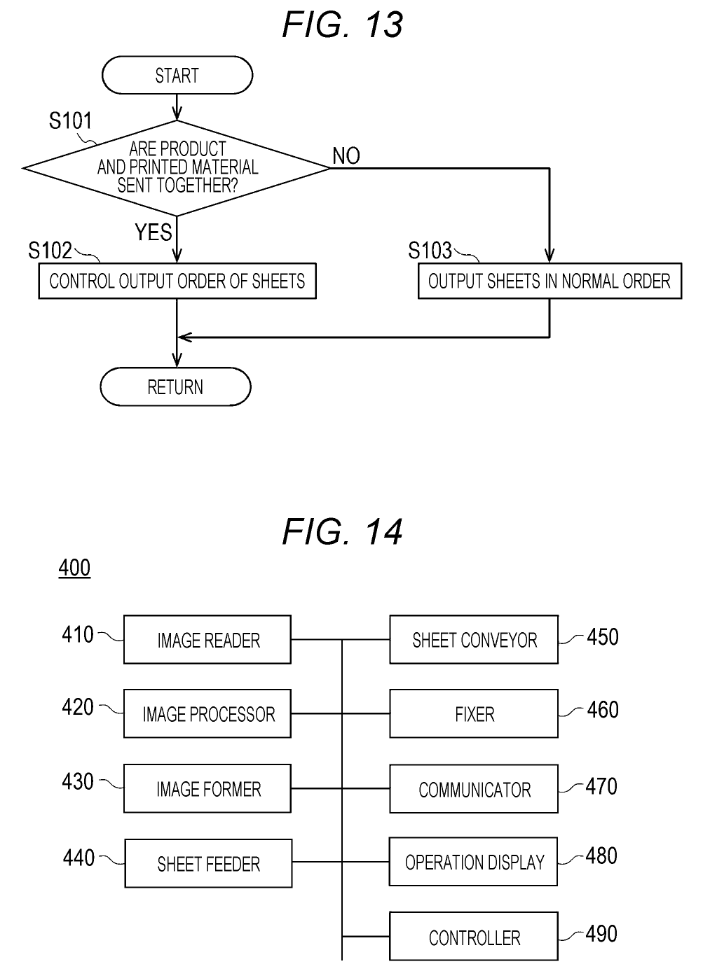

FIG. 13 is a flowchart illustrating the procedure of processing of controlling the output order of sheets. The processing in FIG. 13 is implemented by a server of the printing support system 300 executing a control program.

In the present embodiment, the controller controls the output order of the printed materials on the basis of the fact that the product and the printed materials are to be sent together. When the product and the printed materials are to be sent together, a print job is generated on the basis of the bundled flyer setting selected according to the bundling condition setting. The controller recognizes (determines) that the product and the printed material are to be sent together, for example, when the print job is generated based on the bundled flyer setting selected in accordance with the bundling condition setting. In addition, the controller may recognize (determine) that the product and the printed material are to be sent together on the basis of the reception of a specific operation such as the activation of a specific program or the selection of a bundling flyer mode.

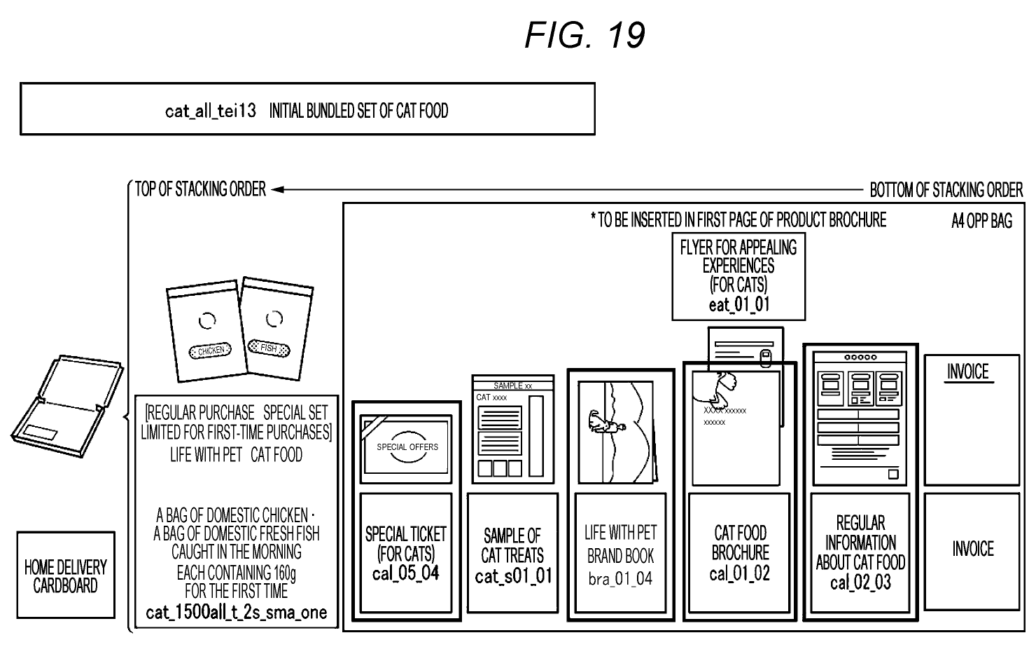

As illustrated in FIG. 13, when the product and the printed materials are to be sent together (step S101), the controller controls the output order of the printed materials, for example, based on the state when the printed materials are sent together with the product (step S102). The printed material can include a plurality of sheets each having a different image formed thereon. The state when the printed materials are sent together with the product is, for example, the stacking order of the printed materials as illustrated in FIGS. 4, 10, and 12, and can be specified by the product information and the customer information. The stacking order of the printed materials corresponds to the order designated in advance by a brand owner. Conventionally, a worker has created a set of flyers to be bundled with a product in a cardboard box or the like according to a pattern table (see, for example, FIG. 19) indicating the configuration of flyers according to an instruction of a brand owner. In the present embodiment, instead of the worker creating a set of flyers, the controller controls the order of printing of the documents or the order of ejection onto a sheet ejection tray so that the stacking order of the set of flyers is reproduced.

On the other hand, when the product and the printed materials are not to be sent together, the controller outputs the printed materials in a normal order (step S103). For example, the controller outputs documents such as a cover letter and a shipping list, which are not sent together with the product, in a normal order.

As illustrated in FIG. 7 again, the product customer extractor 314 extracts product information and customer information from the cart list information, and outputs the extracted information to the image forming apparatus 400.

### Image forming apparatus 400

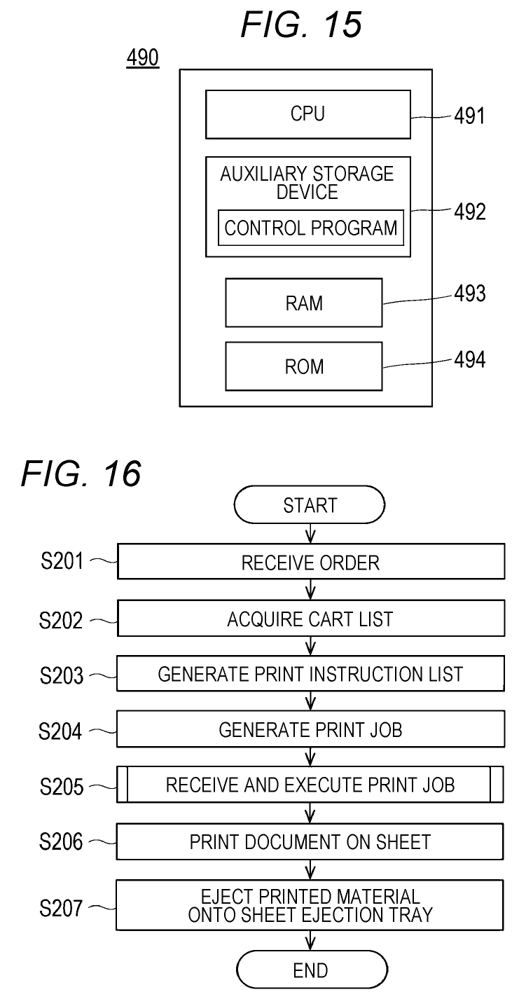

FIG. 14 is a schematic block diagram illustrating the configuration of the image forming apparatus 400 illustrated in FIG. 1, and FIG. 15 is a schematic block diagram illustrating the configuration of a controller 490 illustrated in FIG. 14. The image forming apparatus 400 receives a print job from the printing support system 300 and forms (prints) an image on a sheet (recording medium). The print job includes, for example, print data in a page description language (PDL) format and print settings. The print data includes, for example, data of first to N-th pages. In the present embodiment, the image forming apparatus 400 generates a printed material to be sent together with a product. In the present specification, sending the product and the printed material together means sending the printed material together with the product in a bundled or enclosed manner.

The image forming apparatus 400 includes an image reader 410, an image processor 420, an image former 430, a sheet feeder 440, a sheet conveyor 450, a fixer 460, a communicator 470, an operation display 480, and a controller 490. These constituent elements are connected to one another by an internal bus.

### Image reader 410

The image reader 410 includes an optical system including a mirror, a lens, and the like, and a reading sensor. The image reader 410 reads a document placed on a reading surface or a document conveyed by an auto document feeder (ADF), and outputs an image signal.

### Image processor 420

The image processor 420 generates print image data on the basis of print data and print settings included in the print job received from the printing support system 300 through the communicator 470. More specifically, the image processor 420 analyzes the print job received from the printing support system 300, and performs processing such as color conversion, screening, and rasterization on each page of the print data to generate print image data in a bitmap format. The image processor 420 includes a buffer (memory) that temporarily stores a plurality of print jobs received from the printing support system 300. The image processor 420 also includes an image memory that temporarily stores the generated print image data.

The image processor 420 generates print image data by performing various types of image processing on the image signal received from the image reader 410. The generated print image data is transmitted to the image former 430.

### Image former 430

The image former 430 forms an image on a sheet on the basis of print image data using a known image forming process such as an electrophotographic method including charging, exposing, developing, and transferring. The image former 430 includes a photosensitive drum which is an image bearing member, and a charger, an optical writer, a developing device, and a transferer which are disposed around the photosensitive drum.

The photosensitive drum is rotated at a predetermined speed by a drum motor (not illustrated). The charger includes a corona discharge pole disposed around the photosensitive drum, and charges the surface of the photosensitive drum with generated ions. The optical writer has a scanning optical device incorporated therein, and exposes the charged photosensitive drum based on the input print image data to reduce the potential of the exposed portion, thereby forming a charge pattern (electrostatic latent image) corresponding to the print image data. The developing device develops the formed electrostatic latent image and visualizes it with toner to form a toner image. The transferer transfers the toner image on the photosensitive drum to a sheet.

### Sheet feeder 440

The sheet feeder 440 supplies a sheet as a recording material to the image former 430. The sheet feeder 440 includes an upper tray and a lower tray, and the trays can store sheets of different sizes such as A4 and A3 sizes.

### Sheet conveyor 450

The sheet conveyor 450 conveys a sheet in the image forming apparatus 400. The sheet conveyor 450 includes a conveyance path and a plurality of conveyance roller pairs for conveying a sheet. The sheet conveyor 450 also includes a sheet reversing section that reverses the sheet subjected to fixing by the fixer 460 and ejects the sheet. The sheet conveyor 450 further includes a circulation conveyor for supplying the sheet subjected to the fixing to the image former 430 again. The controller 490 controls the sheet conveyor 450 to supply the sheet reversed by the sheet reversing section to the image former 430 again by the circulation conveyor, thereby forming images on both sides of the sheet.

The sheet fed from the sheet feeder 440 is conveyed through a conveyance path toward the image former 430. The sheet is synchronized with the toner image formed on the photosensitive drum at a registration roller pair, and a timing at which the sheet is conveyed to the transferer is controlled. The sheet on which the toner image has been transferred by the transferer is conveyed to the fixer 460. Next, the sheet on which the image is fixed by the fixer 460 is conveyed to the circulation conveyor or ejected to the sheet ejection tray.

Furthermore, the controller 490 can control (change) the order of ejection of sheets onto the sheet ejection tray by controlling the sheet conveyor 450 so that, while a preceding sheet is being circulated in the circulation conveyor, a subsequent sheet is ejected first to the sheet ejection tray.

The sheet conveyor 450 can also have a retract section that temporarily retracts the sheet to the conveyance path. The retract section can be installed, for example, in a conveyance path from the fixer 460 to the sheet ejection tray. The controller 490 controls the sheet conveyor 450 so that, while the preceding sheet is retracted to the retract section after fixing, the subsequent sheet is subjected to fixing by the fixer 460 and ejected first to the sheet ejection tray. Thus, the sheet conveyor 450 can control (change) the order of ejection of sheets onto the sheet ejection tray.

### Fixer 460

The fixer 460 fixes a toner image formed on the sheet. The fixer 460 includes a hollow heating roller having a heater therein and a pressure roller facing the heating roller. The heating roller and the pressure roller are controlled at a predetermined temperature (e.g., 160 °C or more) by the heater and apply heat and pressure to the sheet to fix the toner image.

### Communicator 470

The communicator 470 is connected to, for example, a client terminal via a communication line and transmits and receives data such as jobs.

### Operation display 480

The operation display 480 includes an input section and an output section. The input section includes, for example, a keyboard and a touch screen, and is used for a worker to perform various kinds of instructions (inputs) such as character input, various kinds of settings, and a start instruction. The output section includes a display, and is used to present, to the worker, a device configuration, an execution status of a job, post-processing executable conditions, an output image, an occurrence status of abnormality (jam) in sheet conveyance, and the like.

### Controller 490

The controller 490 controls the image reader 410, the image processor 420, the image former 430, the sheet feeder 440, the sheet conveyor 450, the fixer 460, the communicator 470, and the operation display 480. As illustrated in FIG. 15, the controller 490 includes a CPU 491, an auxiliary storage device 492, a RAM 493, and a ROM 494.

The CPU (hardware processor) 491 controls each section of the image forming apparatus 400 by executing a control program for the image forming apparatus. The control program is stored in the auxiliary storage device 492 and is loaded onto the RAM 493 when the program is executed by the CPU 491. The auxiliary storage device 492 includes, for example, a large-capacity storage device such as a hard disk drive and a flash memory. The RAM 493 stores a calculation result or the like accompanied by the execution of the CPU 491. The ROM 494 stores various parameters, various programs, and the like. The CPU 491 implements various functions by executing the control program.

In the present embodiment, the controller 490 controls the output order of output of the printed materials by executing the control program. The output order of the printed materials can be controlled by at least one of execution of the print job, formation (printing) of an image on a sheet based on print image data generated by the execution of the print job, or ejection of the printed material, that is, the sheet on which the image is formed. The details of control of the output order of the printed materials will be described later.

### Method for printing flyer in EC system

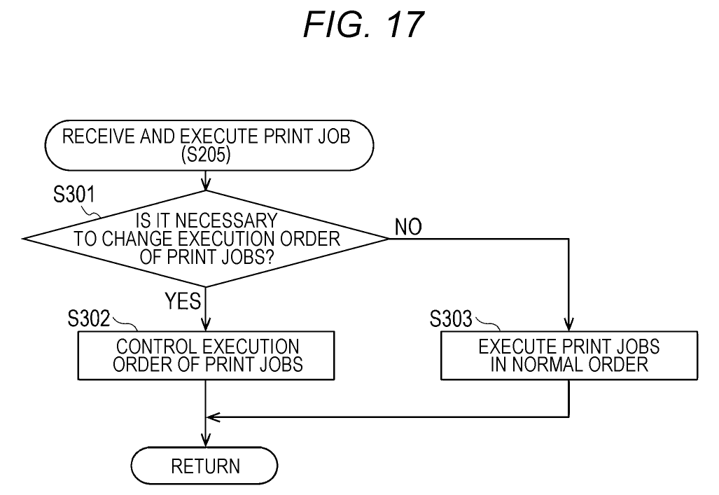

FIG. 16 is a flowchart illustrating the procedure of a method for printing a flyer in the EC system according to the first embodiment. In the following, a case where the customer orders the product a1 of the company A will be described as an example. The same applies to a case where the customer orders another product of the company A or a product of the company B or the company C. The process of step S201 in FIG. 16 is implemented by the server 21 of the company A. In addition, the processes of steps S202 to S204 in FIG. 16 are implemented by the server of the EC specialized logistics center 30. Furthermore, the processes of steps S205 to S207 in FIG. 16 are implemented by the CPU 491 executing the control program. FIG. 17 is a subroutine flowchart illustrating the details of a process (step S205) of receiving and executing a print job in FIG. 16.

As illustrated in FIG. 16, the customer operates the customer terminal 10 to place an order for the product a1 on the EC site of the company A. The customer terminal 10 transmits ordering information to the cart system of the company A. The ordering information may include, for example, information such as an order date and time of the product a1, the product name, a quantity, the name, address, and contact information of the customer, a delivery destination name, and a delivery destination address.

The cart system of the company A receives the order (step S201). The cart system of the company A generates product information regarding the product a1 and the customer information based on the received ordering information and production information (e.g., the serial number, the date of manufacture, the manufacturing line, etc.) of the product a1. The cart system of the company A outputs a cart list including the product information and the customer information to the warehouse management system 100 and the printing support system 300.

Upon receiving the shipping instruction, the warehouse management system 100 generates a management number and creates a shipping list of the product on the basis of the cart list and the information regarding the inventory acquired from the warehouse 200. The worker creates a shipping instruction list based on the shipping list and the management number.

Next, the printing information acquirer 310 acquires the cart list (step S202). The acquired cart list is saved in the cart list database 312.

Next, the print instruction list generator 313 generates a print instruction list on the basis of the shipping instruction list, the bundled flyer setting, the bundling condition setting, and the cart list information (step S203). The shipping instruction list created by the worker is input to the print information acquirer 310. The bundled flyer setting and the bundling condition setting are transmitted from the server 21 to the print information acquirer 310 and are stored in advance in the setting information storage 311. The cart list information is acquired from the cart list database 312.

Next, the print job generator 330 generates a print job based on the print instruction list and document data (step S204). More specifically, the print job generator 330 generates a print job by using a print instruction list including the bundled flyer setting selected according to the bundling condition setting and document data corresponding to the bundled flyer setting. When the product and the printed materials are to be sent together, the print job generator 330 generates a print job in the order of the documents defined by the bundled flyer setting. The generated print job is transmitted to the image forming apparatus 400.

Next, the image processor 420 receives the print job through the communicator 470 and stores the print job in the buffer. The image processor 420 executes the print job stored in the buffer (step S205). The controller 490 can control the order in which the image processor 420 executes print jobs for generating printed materials to be sent together with the product. Thus, the controller 490 can control the output order of the printed materials. Controlling the output order of printed materials has the following advantages.

For example, it is highly likely that the same product is stored in the same product storage area of the warehouse 200 or in a neighboring product storage area. Furthermore, even different products may be stored in neighboring product storage areas. If the worker can pick products from the same product storage area or neighboring product storage areas as much as possible when picking a plurality of products in one picking operation, the efficiency is improved as compared to the case where the worker moves between product storage areas distant from each other.

In view of such circumstances, the controller 490 can control, based on the information in the shipping instruction list, the order of execution of the print jobs so as to achieve the order of ejection of the printed materials according to the order of shipping works that enables efficient shipping work for shipping the product by the worker. For example, the controller 490 can control, based on the information in the shipping instruction list, the order of execution of print jobs so as to achieve the order of ejection of the printed materials according to the picking order that enables efficient picking work for picking the products by the worker. In addition, the controller 490 can control the execution order of the print jobs based on the information in the shipping instruction list so as to achieve the ejection order of the printed materials according to the loading order that enables efficient loading work for loading the products by the worker.

As illustrated in FIG. 17, the controller 490 determines whether or not it is necessary to change the execution order of the print jobs from the information in the shipping instruction list (step S301), and when it is necessary to change the execution order of the print jobs (Yes in step S301), the controller 490 controls the execution order of the print jobs by the image processor 420. For example, the controller 490 can control the execution order of the print jobs on the basis of product information, customer information, or information about shipping work.

The product information may include at least one of information regarding the type of the product, information regarding the product storage area, and information regarding the delivery company of the product. The information regarding the type of the product can include, for example, the name, type, and category of the product such as the products a1 to a3, b1, b2, and c1. The information regarding the product storage area may include, for example, a unique code or name indicating the position, region, or the like of the product storage area. For example, numerical values close to each other or codes having similar names can be assigned to the product storage areas which are close to each other. Further, the information regarding the delivery company of the product may include a unique code or name indicating the delivery company.

For example, the controller 490 can perform control to continuously execute print jobs having the same or similar product information among a plurality of print jobs stored in the buffer of the image processor 420.

On the other hand, when it is not necessary to change the execution order of the print jobs (No in step S301), the controller 490 executes the print jobs in a normal order (step S303). That is, the controller 490 controls the image processor 420 so that the print jobs are executed in the order stored in the buffer of the image processor 420.

Furthermore, the controller 490 can classify a plurality of print jobs stored in the buffer of the image processor 420 into a plurality of groups according to categories, and can register the groups of the classified print jobs. The controller 490 can classify the print jobs by using, for example, a type of product, a delivery company, or the like as a category. More specifically, the controller 490 can classify print jobs for generating printed materials to be sent together with products of the same type or products to be delivered by the same delivery company into the same group.

Further, a group classified according to a certain category can be further classified according to another category to create a group. That is, a subgroup can also be created for a group. For example, the groups classified according to the delivery companies may be further classified according to the types of products to create subgroups. In this way, by classifying a plurality of print jobs into groups (or subgroups), the efficiency of the shipping work related to the same category in a group (or subgroup) can be improved. For example, since at least delivery companies are the same for unclassified print jobs in a group classified by delivery companies, the efficiency of the loading work is expected to be improved. Furthermore, since at least the delivery company and the type of the product are the same for the subgroup classified according to the type of the product in addition to the delivery company, the efficiency of the loading work and the picking work is expected to be improved. In addition, when there are the same categories in the group (or the subgroup), the categories can be easily searched. The controller 490 can control the image processor 420 so that print jobs in the same group (subgroup) are continuously executed.

Next, the image former 430 prints the document on the sheet (step S206). More specifically, the controller 490 controls the image former 430 so that an image is formed on a sheet based on the print image data generated by the image processor 420. In the present embodiment, the controller 490 forms the print images on the sheets in a normal order. That is, the controller 490 forms the print images on sheets in the order stored in the image memory of the image processor 420.

Next, the sheet conveyor 450 ejects the printed material onto the sheet ejection tray (step S207). More specifically, the controller 490 controls the sheet conveyor 450 so that the printed material on which the image is printed is ejected onto the sheet ejection tray. In the present embodiment, the controller 490 normally ejects the printed material onto the sheet ejection tray. That is, the controller 490 ejects the printed materials onto the sheet ejection tray in the order in which they are printed.

As described above, in the present embodiment, in a case where a product and printed materials are to be sent together, the controller 490 can control the output order of output of the printed materials by the image forming apparatus 400 on the basis of the product information, the customer information, or the information about the shipping work.

Although the case where the image formation order and the ejection order of the printed materials are as normal has been described, the image formation order and the ejection order of the printed materials may also be controlled on the basis of the bundled flyer setting and the bundling condition setting, even when the execution order of print jobs are changed.

### Modification example

The above-described example has described a case where orders scheduled to be shipped on a specific date (for example, today) are filtered from the shipping list, the worker creates a work batch for a plurality of items scheduled to be shipped, and a shipping instruction list is created for each work batch. However, the present embodiment is not limited to such a case, and the printing support system 300 can automatically create a work batch from a shipping list having items scheduled to be shipped on a specific date, and generate a shipping instruction list for each work batch.

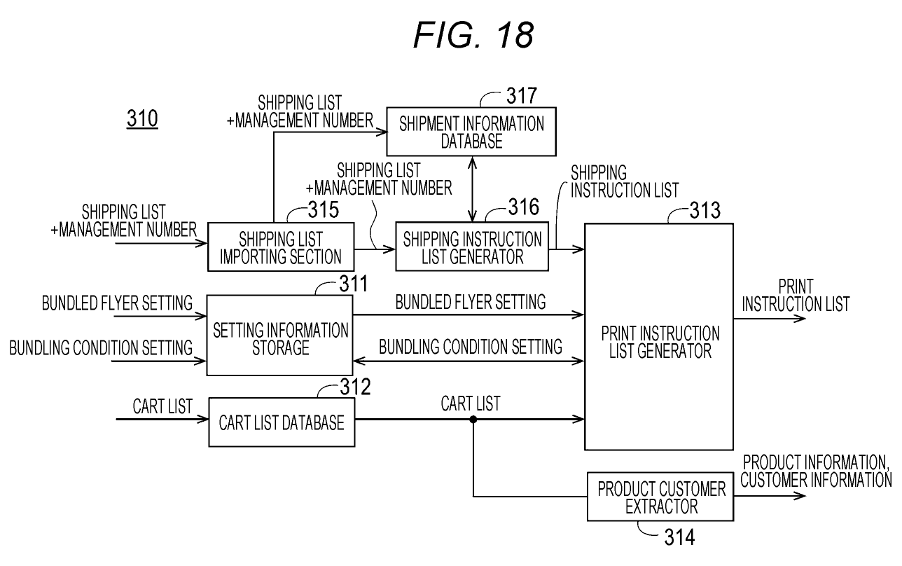

FIG. 18 is a schematic block diagram illustrating a modification example of the configuration of the printing information acquirer 310 illustrated in FIG. 6. The print information acquirer 310 in the present modification example includes a setting information storage 311, a cart list database 312, a print instruction list generator 313, a shipping list importing section 315, a shipping instruction list generator 316, and a shipment information database 317. The shipping list importing section 315 imports the shipping list together with the management number from the warehouse management system 100, and transmits the imported shipping list and management number to the shipping instruction list generator 316 and the shipment information database 317.

### SHIPPING INSTRUCTION LIST

The shipping instruction list generator 316 generates a shipping instruction list on the basis of the latest shipping list and management number imported by the shipping list importing section 315 and the shipping list and management number already stored in the shipment information database 317. The shipping instruction list generator 316 can create a shipping instruction list, for example, according to the following procedure.
1. Create a list of products scheduled to be shipped today from the latest shipping list imported by the shipping list importing section 315 and the shipping list in the shipment information database 317, and divide the generated list into a plurality of pieces for each delivery company of the products.
2. Extract only items for which only the same products are ordered from the list divided for each delivery company and group the extracted items.
3. Sort each group of the grouped list by the number of products.
4. Set a reference number of items of one work batch, a maximum (MAX) number of items of one work batch, and a minimum (MIN) number of items of one work batch.
5. Divide the number of items of one work batch for each predetermined number of items.

For example, when the reference number of items is 100, the MAX number of items is 150, and the MIN number of items is 50, the number of items is divided as follows.

When the number of items for shipping one product a1 is 95, set the 95 items as one work batch.

When the number of items for shipping one product a1 is 145, set the 145 items as one work batch.

When the number of items for shipping one product a1 is 155 which is greater than the MAX number of items, substantially equally divide the 155 items into two and set 78 items as one work batch and 77 items as one work batch.

When the number of items for shipping one product a1 is 30, the number of items for shipping two products a1 is 15, and the number of items for shipping three products a1 is 10, the total of 30, 15, and 10 is 55 which is greater than the MIN number of items and smaller than the MAX number of items. Thus, set the 55 items as one work batch.

When there are 30 products a2 and 25 products c1, the total of 30 and 25 is 55 which is greater than the MIN number of items and smaller than the MAX number of items. Thus, set the 55 items obtained by adding the number of products a2 and the number of products c1 as one work batch.

Note that, when printing is performed based on the generated shipping instruction list, a divider sheet can be inserted between work batches so that the delimiters for each work batch are easy to understand.

### Example of pattern table for flyer to be bundled with product

FIG. 19 is a schematic diagram illustrating a pattern table of a flyer to be bundled with a product. The pattern table is a table indicating a flyer image for each page, a description of the image, a file name, and the stacking order of the pages. FIG. 19 illustrates a pattern table for a flyer bundled with cat food. The pattern table in FIG. 19 illustrates that the flyer is bundled with the product at the time of the first regular purchase and is sent to the customer.

### Current shipping work as comparative example

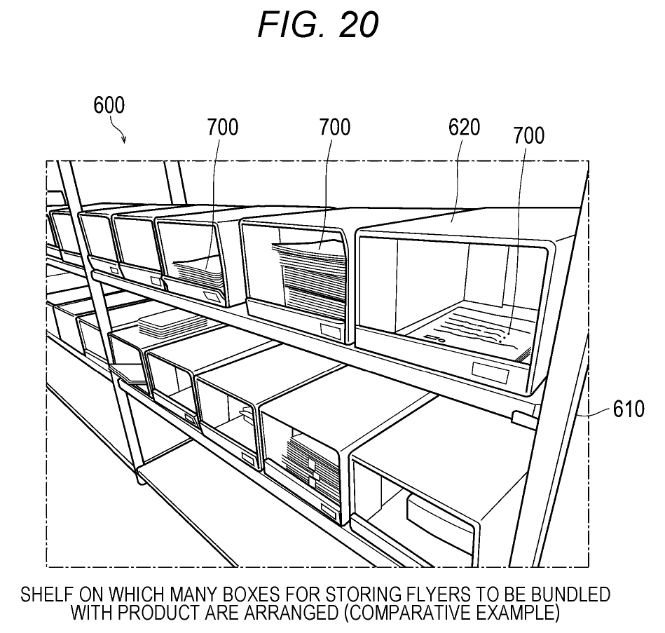

FIG. 20 is a schematic diagram illustrating a shelf 610 on which many boxes 620 for storing flyers are arranged. At present, the shelf 610 is installed in a flyer storage area 600 of the EC specialized logistics center 30, and many boxes 620 for storing flyers 700 are arranged side by side on the shelf 610. The worker picks a flyer 700 from the shelf 610 on which the corresponding flyer 700 is placed according to a product to be sent and packages the flyer 700 together with the product when shipping the product.

However, the flyer 700 to be bundled with a product has various patterns depending on the product, regular purchase, the number of purchase, and the like. In addition, when there are a plurality of flyers 700 to be bundled with the product, the stacking order is also usually designated by the brand owner in advance. The worker manually picks the flyer 700 while looking at the pattern table of the flyer 700. The flyers 700 are manually picked, so that a mistake tends to occur.

As described above, under the current situation, a worker creates a set of flyers in advance in his/her spare time for each purchased product or for each number of purchases, for example, and when picking a product, the worker also picks the created set of flyers. However, there is a case where a flyer to be bundled with a product is changed depending on products, regular purchases, the number of purchases, or the like. In addition, a flyer to be bundled may be frequently changed depending on the season, a model change of products, or the like. In such a case, the volume of work of the worker at the site where the product is shipped increases. Further, in such a case, flyers which cannot be used have to be discarded, although the flyers which can be used even after the change may be extracted from the set and used.

### SECOND EMBODIMENT

The first embodiment has described the case where the controller 490 generates print jobs or groups of print jobs on the basis of the bundled flyer setting and the bundling condition setting in order to generate printed materials to be sent together with products, and controls the output order of the printed materials. The second embodiment will describe a case where the controller 490 controls the order of formation of print images on sheets for a plurality of print jobs on the basis of the bundled flyer setting and the bundling condition setting, thereby controlling the output order of printed materials. That is, in the second embodiment, unlike the first embodiment in which a job is created based on the bundled flyer setting and the bundling condition setting, the controller 490 changes the printing order based on the bundled flyer setting and the bundling condition setting, thereby creating a set of flyers to be bundled. In the following, in order to avoid duplication of description, description of the same configuration as the configuration of the first embodiment will be omitted or simplified.

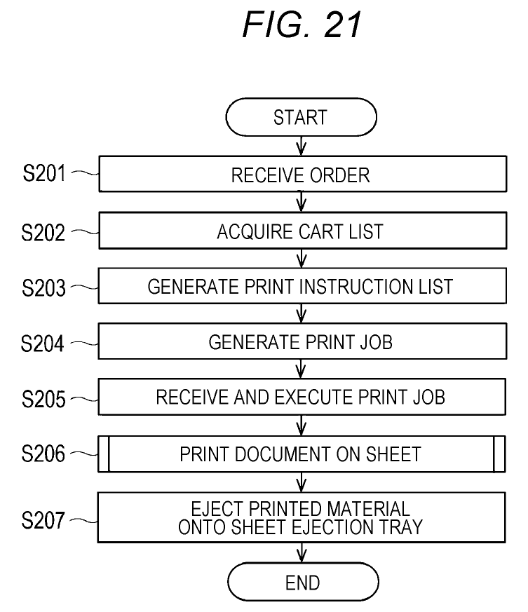

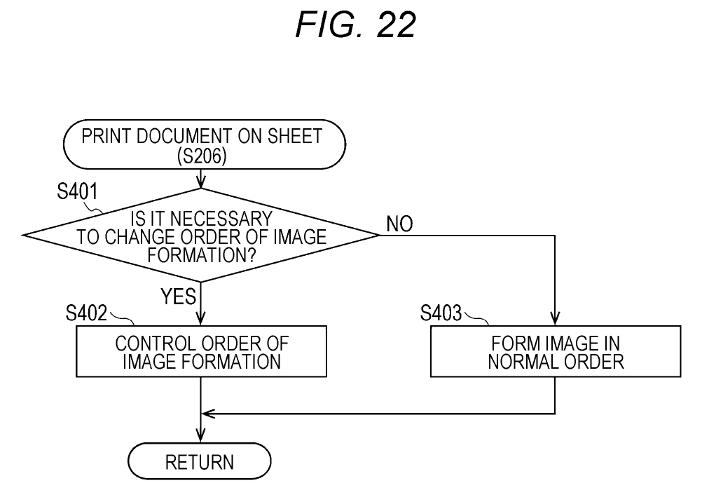

FIG. 21 is a flowchart illustrating the procedure of a method for printing a flyer in an EC system according to the second embodiment. The processes of steps S201 to S204 and S207 in FIG. 21 are the same as the processes of steps S201 to S204 and S207 in FIG. 16. FIG. 22 is a subroutine flowchart illustrating the details of the process (step S206) of printing a document on a sheet in FIG. 21.

### Step S205

As illustrated in FIG. 21, an image processor 420 executes the print job stored in a buffer. In the present embodiment, a controller 490 executes the print jobs in a normal order. That is, the controller 490 controls the image processor 420 so that the print jobs are executed in the order stored in the buffer of the image processor 420.

### Step S206

An image former 430 prints a document on the sheet. The controller 490 controls the image former 430 so that an image is formed on the sheet based on the print image data generated by the image processor 420. The controller 490 controls the output order of printed materials by controlling the order of formation of images on a plurality of sheets on the basis of the bundled flyer setting and the bundling condition setting.

More specifically, as illustrated in FIG. 22, the controller 490 determines whether or not it is necessary to change the order of image formation from the bundled flyer setting and the bundling condition setting (step S401), and when it is necessary to change the order of image formation (YES in step S401), the controller 490 controls the order of image formation (step S402). The controller 490 controls the image former 430 so that images are formed on the sheets in the order of documents defined by the bundled flyer setting and the bundling condition setting. The controller 490 can also control the order of formation of a plurality of print images selected based on the product information onto the sheets. The product information may include at least one of information regarding the type of the product, information regarding the product storage area, and information regarding the delivery company of the product. The controller 490 can perform, for example, control to continuously print the print images of the print jobs having the same or similar product information among a plurality of print images stored in an image memory of the image processor 420.

The controller 490 can also control the order of formation of a plurality of print images selected based on a plurality of pieces of print image data onto the sheets on the basis of customer information or information about a shipping work. The controller 490 can perform, for example, control to continuously print the print images of the print jobs having the same or similar customer information among a plurality of print images stored in the image memory of the image processor 420.

On the other hand, when it is not necessary to change the order of image formation (No in step S401), the controller 490 forms the print images onto the sheets in a normal order (step S403). That is, the controller 490 forms the print images on the sheets in the order stored in the image memory of the image processor 420.

Note that not only the document of the printed material to be sent together with the product, but also a document not to be sent together with the product, such as a cover letter or a shipping list, may be printed together with the document. For example, in a case where an invoice is to be enclosed, a document included in the bundled flyer setting and a document formed by integrating a cover letter, a shipping list, and the invoice are printed together, so that it is not necessary to collate the product with the printed material to be bundled.

### THIRD EMBODIMENT

The third embodiment will describe a case where a controller 490 controls the order of ejection of a plurality of printed materials on the basis of the bundled flyer setting and the bundling condition setting, thereby controlling the output order of the printed materials. That is, in the third embodiment, unlike the first embodiment in which a job is created based on the bundled flyer setting and the bundling condition setting, the controller 490 changes the order of ejection of the printed materials based on the bundled flyer setting and the bundling condition setting, thereby creating a set of flyers to be bundled. In the following, in order to avoid duplication of description, description of the same configuration as the configuration of the first embodiment will be omitted or simplified.

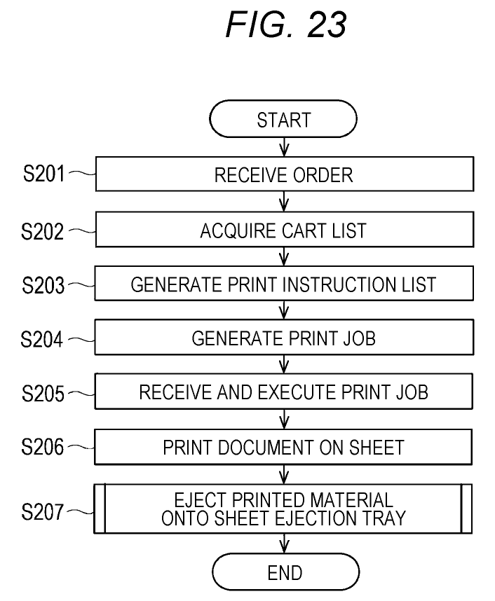

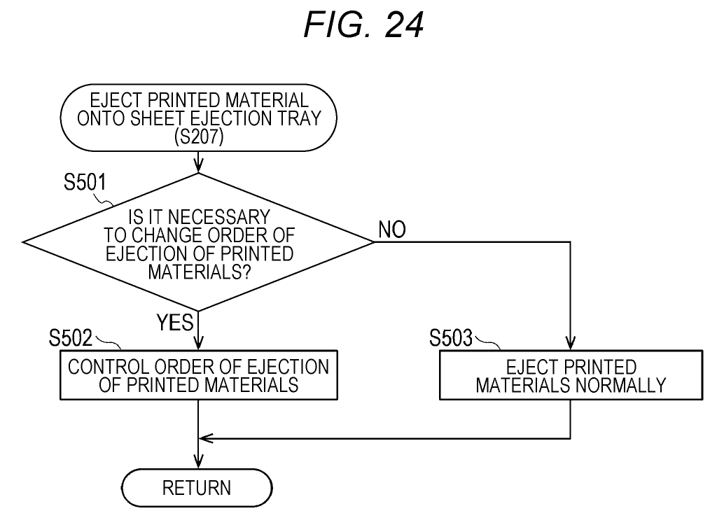

FIG. 23 is a flowchart illustrating the procedure of a method for printing a flyer in an EC system according to a third embodiment. The processes of steps S201 to S204 and S206 in FIG. 23 are the same as the processes of steps S201 to S204 and S206 in FIG. 16. FIG. 24 is a subroutine flowchart illustrating the details of processing (step S207) of ejecting a printed material onto a sheet ejection tray in FIG. 23.

### Step S205

As illustrated in FIG. 23, an image processor 420 executes the print job stored in a buffer. In the present embodiment, the controller 490 executes the print jobs in a normal order. That is, the controller 490 controls the image processor 420 so that the print jobs are executed in the order stored in the buffer of the image processor 420.

### Step S207

A sheet conveyor 450 ejects the printed material onto a sheet ejection tray. The controller 490 controls the sheet conveyor 450 so that the printed material on which the image is printed is ejected onto the sheet ejection tray. The controller 490 controls the output order of the printed materials by controlling the order of ejection of a plurality of printed materials based on the bundled flyer setting.

More specifically, as illustrated in FIG. 24, the controller 490 determines whether or not it is necessary to change the order of ejection of the printed materials from the bundled flyer setting and the bundling condition setting (step S501), and when it is necessary to change the order of ejection of the printed materials (YES in step S501), the controller 490 controls the order of ejection of the printed materials (step S502). The controller 490 controls the sheet conveyor 450 so that the printed materials are ejected onto the sheet ejection tray in the order of documents defined by the bundled flyer setting and the bundling condition setting. The controller 490 can also control the order of ejection of a plurality of sheets on which images have been formed, on the basis of product information. The product information may include at least one of information regarding the type of the product, information regarding the product storage area, and information regarding the delivery company of the product. The controller 490 can perform, for example, control to successively eject the printed materials of print jobs having the same or similar product information among a plurality of print jobs stored in the buffer of the image processor 420.

In addition, the controller 490 can control the order of ejection of the printed materials based on customer information or information about a shipping work. The controller 490 can perform, for example, control to successively eject the printed materials of print jobs having the same or similar customer information among a plurality of print jobs stored in the buffer of the image processor 420.

On the other hand, when it is not necessary to change the order of ejection of the printed materials (No in step S501), the controller 490 normally ejects the printed materials onto the sheet ejection tray (step S503). That is, the controller 490 ejects the printed materials onto the sheet ejection tray in the order in which they are printed.

### Effect of image forming system 500 according to first to third embodiments

The image forming system 500, the method for controlling the image forming system 500, and the control program according to the first to third embodiments have the following effects.

The printing support system 300 controls the output order of output of printed materials by the image forming apparatus 400 on the basis of the fact that the product and the printed materials are to be sent together. More specifically, when the product and the printed materials are to be sent together, the print job generator 330 generates print jobs in the order of documents defined by the bundled flyer setting and the bundling condition setting created in advance by the EC company. The image forming apparatus 400 prints an image on a sheet on the basis of the print job generated by the print job generator 330, and ejects the sheet onto the sheet ejection tray.

Furthermore, the controller 490 can control the image former 430 so that documents of print jobs generated without using the bundled flyer setting and the bundling condition setting are formed onto sheets in the order of the documents defined by the bundled flyer setting and the bundling condition setting created in advance by the EC company.

In addition, the controller 490 controls the sheet conveyor 450 so that the sheets on which images are formed by the image former 430 are ejected onto the sheet ejection tray in the order of the documents defined by the bundled flyer setting and the bundling condition setting created in advance by the EC company.

Thus, the printed materials are ejected onto the sheet ejection tray in the order of the documents defined by the bundled flyer setting and the bundling condition setting created in advance by the EC company. Therefore, it is possible to prevent or reduce a worker’s mistake in the bundling in the shipping work, and it is also possible to reduce time and effort for the worker to create a set of flyers in advance. Furthermore, since the image forming apparatus 400 generates only necessary printed materials on the basis of the above print jobs, it is possible to reduce printed materials to be discarded due to a change in the set of flyers to be sent together.

In addition, the controller 490 controls, for the plurality of print jobs for generating the printed materials to be sent together with the product, the execution order thereof, the order of printing of print images, or the order of ejection of the printed materials onto the sheet ejection tray on the basis of the information in the shipping instruction list. For example, the controller 490 controls the output order of output of printed materials by controlling the execution order of print jobs, the printing order of print images, or the ejection order of printed materials onto a sheet ejection tray, on the basis of the product information and/or the customer information. More specifically, the controller 490 creates a work batch with the same delivery company, the same type of product, or the like, and continuously executes print jobs of the work batch to print the print images of the print jobs or eject the printed materials. Thus, the image forming apparatus 400 can continuously eject printed materials corresponding to products of the same delivery company or the same type onto the sheet ejection tray. Therefore, the worker can continuously pick and acquire products of the same type, pack each product and the printed material together, and continuously load them onto a truck of the same delivery company, thus improving the efficiency of shipping work.

The image forming system 500, the method for controlling the image forming system 500, and the control program have been described above in the embodiment. However, it is obvious that those skilled in the art can appropriately make addition, modifications, and omissions with respect to the present invention within the scope of the technical idea thereof.

For example, the printing support system 300 may generate a cover letter, an invoice, or a flyer in combination with the input shipping instruction list or information stored in the cart list database 312 or the like in advance without using document data (for example, PDF format) created in advance.

In addition, two or more of the first to third embodiments may be implemented in combination. That is, the controller 490 can also control the output order of the printed materials by controlling, on the basis of the bundled flyer setting and the bundling condition setting, at least two of the order of execution of the print jobs by the image processor 420, the order of formation of print images on sheets by the image former 430, and the order of ejection of the printed materials by the sheet conveyor 450.

Furthermore, the control program may be provided by a non-transitory computer-readable storage medium, such as a USB memory, a flexible disk, or a CD-ROM, or may be provided online via a network, such as the Internet. In this case, the control program recorded on the non-transitory computer-readable storage medium is usually transferred to and stored in a memory, a storage, or the like. Furthermore, this control program may be provided, for example, as independent application software, or may be incorporated, as one function of the server, into software of each apparatus.

While the embodiments of the present invention have been described and illustrated in detail, the disclosed embodiments have been created for purposes of illustration and example only, and not limitation. The scope of the present invention should be interpreted by the wording of the accompanying claims.

What is claimed is:

1. An image forming system comprising a hardware processor that controls an output order of output of printed materials to be sent together with a product by an image forming apparatus that generates the printed materials, wherein
the hardware processor controls the output order of the printed materials based on a fact that the product and the printed materials are to be sent together.

2. The image forming system according to claim 1, wherein the output includes formation of images on a plurality of recording media by the image forming apparatus, and
the hardware processor controls an order of formation of the images on the plurality of recording media.

3. The image forming system according to claim 1, wherein the output includes ejection of a plurality of recording media on which images have been formed by the image forming apparatus, and the hardware processor controls an order of ejection of the plurality of recording media.

4. The image forming system according to claim 1, wherein, for the printed materials including a plurality of recording media on which different images are formed, the hardware processor controls the output order of the printed materials based on a state when the printed materials are sent together with the product.

5. The image forming system according to claim 4, wherein the hardware processor specifies, based on product-related information regarding the product, the state when the printed materials are sent together with the product.

6. The image forming system according to claim 5, wherein the hardware processor determines an order of formation of images of a plurality of pieces of print data selected based on the product-related information on the recording media.

7. The image forming system according to claim 5, wherein the hardware processor determines an order of ejection of the plurality of recording media on which images have been formed, based on the product-related information.

8. The image forming system according to claim 4, wherein the hardware processor specifies the state when the printed materials are sent together with the product, based on user-related information regarding a user who has ordered the product.

9. The image forming system according to claim 8, wherein the hardware processor determines an order of formation of images of a plurality of pieces of print data selected based on the user-related information on the recording media.

10. The image forming system according to claim 8, wherein the hardware processor determines an order of ejection of a plurality of recording media on which images have been formed, based on the user-related information.

11. The image forming system according to claim 1, wherein the hardware processor controls an execution order of image forming jobs for generating the printed materials to be sent together with the product, based on product-related information regarding the product.

12. The image forming system according to claim 11, wherein
the product-related information includes information regarding a place for the product, and
the hardware processor controls the execution order of the image forming jobs based on the information related to the place for the product.

13. The image forming system according to claim 11, wherein the hardware processor performs control in such a manner that, among a plurality of image forming jobs stored in a storage, image forming jobs for generating printed materials to be sent together with a same product are successively executed.

14. The image forming system according to claim 11, wherein the hardware processor
classifies a plurality of image forming jobs stored in a storage into a plurality of groups at a predetermined timing, and
classifies image forming jobs for generating printed materials to be sent together with a same product into a same group.

15. The image forming system according to claim 14, wherein the hardware processor performs control in such a manner that the image forming jobs in the same group are successively executed.

16. The image forming system according to claim 11, wherein the product-related information includes information regarding a delivery company of the product, and
the hardware processor controls the execution order of the image forming jobs based on the information regarding the delivery company of the product.

17. The image forming system according to claim 11, wherein the hardware processor performs control in such a manner that, among a plurality of image forming jobs stored in a storage, image forming jobs for generating printed materials to be sent together with products to be delivered by a same delivery company are successively executed.

18. The image forming system according to claim 11, wherein the hardware processor
classifies a plurality of image forming jobs stored in a storage into a plurality of groups at a predetermined timing, and
classifies image forming jobs for generating printed materials to be sent together with products to be delivered by a same delivery company into a same group.

19. The image forming system according to claim 18, wherein the hardware processor performs control in such a manner that the image forming jobs in the same group are successively executed.

20. A method for controlling an image forming system including an image forming apparatus that generates a printed material to be sent together with a product, the image forming apparatus including a hardware processor, the hardware processor controlling an output order of output of printed materials based on a fact that the product and the printed materials are to be sent together.

21. A non-transitory computer-readable storage medium storing a control program for an image forming apparatus that generates a printed material to be sent together with a product, the control program being a control program for executing processing including a procedure of controlling an output order of output of printed materials based on a fact that the product and the printed materials are to be sent together.
